(19) United States
(12) Patent Application Publication
(10) Pub. No.: US 2002/0190841 A1
(43) Pub. Date: Dec. 19, 2002

(54) Electric resistance element and raw material for the same and method for preparing the same

(76) Inventors: Yukifumi Chiba, Osaka-shi (JP); Hisashi Higuchi, Itami-shi (JP)

Correspondence Address: GREENBLUM & BERNSTEIN, P.L.C., 1941 ROLAND CLARKE PLACE, RESTON, VA, 20191, US

(21) Appl. No.: 10/148,878

(22) PCT Filed: Sep. 25, 2001
(86) PCT No.: PCT/JP01/08292

(30) Foreign Application Priority Data
Sep. 26, 2000 (JP) 2000-292984

(51) Int. Cl. H01C 13/00

(52) U.S. Cl. 338/296; 338/308

(57) ABSTRACT

The material for an electrical resistivity element contains at least 20 mass % and at most 60 mass % of nickel, less than 5 mass % of iron and the remaining part including unavoidable impurities and cobalt. The material for the electrical resistivity element is manufactured by preparing a composition that contains at least 20 mass % and at most 60 mass % of nickel, less than 5 mass % of iron and the remaining part including cobalt, melting and casting the composition to obtain an ingot, removing the surface of the ingot by hot working, and performing cold-working and heat treatment on the hot-worked body.

### TECHNICAL FIELD

The present invention generally relates to an electrical resistivity element, the material thereof and manufacturing method thereof. More particularly, the present invention relates to material for electric resistivity element useful for a glow plug or various types of heaters.

### BACKGROUND ART

Conventionally, material having superior corrosion resistance at high temperature has been used as the material used for resistance heating body. Nichrome and kantal have been used as materials suitable only for the purpose of resistance heating body. Where a temperature control function (referred to as self temperature control function) utilizing the fact that the value of electric resistivity increases as the temperature increases is necessary, a nickel alloy with low content of other elements or a cobalt alloy with high content of other elements is used, which has large temperature coefficient of resistance.

Among conventionally used materials utilizing the temperature control function, various materials have been studied for use with a glow plug or various types of heaters. Among these, the nickel alloy with low content of other elements has large temperature coefficient of electrical resistivity at a low temperature. At a temperature of 400° C. or higher, however, it has a small temperature coefficient of electrical resistivity, and therefore it cannot be used at a high temperature. As for the cobalt alloy with high content of other elements, it contains much iron as disclosed, for example, in Japanese Patent Laying-Open Nos. 58-83124, 2-133901 and 9-112905, and hence it is problematic in view of corrosion resistance and oxidation resistance.

Therefore, an object of the present invention is to provide material for electrical resistivity element of which temperature coefficient of electrical resistivity is large from a low temperature to a high temperature, exhibits the self temperature control function in the temperature range, and has superior corrosion resistance and oxidation resistance.

### DISCLOSURE OF THE INVENTION

The material for the electrical resistivity element in accordance with the present invention contains at least 20 mass % and at most 60 mass % of nickel (Ni), less than 5 mass % of iron (Fe) and a remaining part including unavoidable impurities and cobalt (Co).

In the preferable material for the electrical resistivity element of the present invention, the relation x+7y<70 is satisfied, where contents of nickel and iron mentioned above are represented by x and y, respectively, by the unit of mass %.

Further, in a more preferable material for the electrical resistivity element of the present invention, the contents of unavoidable impurities are as follows: at most 0.1 mass % of carbon (C) only, and at most 0.1 mass % of a total of silicon (Si), titanium (Ti), manganese (Mn), chromium (Cr) aluminum (Al), boron (B) and bismuth (Bi).

Further, a more preferable material for the electrical resistivity element of the present invention contains at most 3 mass % of each of vanadium (V) and tungsten (W) and at most 8 mass % of molybdenum (Mo).

When electrical resistivity of the material for the electrical resistivity element in accordance with the present invention at a room temperature is represented as ρ(RT) and electrical resistivity of the material for the electrical resistivity element at a temperature of 1000° C. is represented as ρ(1000), it is preferred that the ratio ρ(1000)/ρ(RT) is at least 7 and at most 12.

In the electrical resistivity element of the present invention, the material having the above described composition or properties is used. Here, in the electrical resistivity element, the material is used in the shape of a coil.

The method of manufacturing the material for an electrical resistivity element in accordance with the present invention includes the first step of preparing a composition containing at least 20 mass % and at most 60 mass % of nickel, less than 5 mass % of iron and a remaining part including cobalt; the second step of melting and casting the composition to obtain an ingot; the third step of hot working the ingot and removing the surface thereof; and the fourth step of performing cold working and heat treatment on the hot-worked body.

In the method of manufacturing the material for an electrical resistivity element in accordance with the present invention, it is preferred that the manufacturing process is completed by the cold working as the fourth step described above.

In the preferred method of manufacturing the material for an electrical resistivity element in accordance with the present invention, the reduction of the cold working in the fourth step is at least 75%. In a more preferred method of manufacturing a material for an electrical resistivity element in accordance with the present invention, the cold working includes wire-drawing.

According to the present invention, the material for electrical resistivity element having superiority in quick heating characteristic, self temperature control function, corrosion resistance, oxidation resistance and workability can be provided, so that reduction of freedom in practical design of the electrical resistivity element can be increased, and an electrical resistivity element having high performance, long life and high reliability can be provided.

### BRIEF DESCRIPTION OF THE DRAWINGS

FIG. 1 is a graph representing composition range of the material for the electrical resistivity element in accordance with the present invention.

FIG. 2 is a graph representing the change in resistance ratio with respect to temperature of the materials obtained by the embodiment of the present invention.

### BEST MODE FOR CARRYING OUT THE INVENTION

The first characteristic of the material for an electrical resistivity element of the present invention to attain the above described objects is that the material has such a composition that contains at least 20 mass % and at most 60 mass % of nickel, less than 5 mass % of iron and the remaining part including unavoidable impurities and cobalt.

Generally, various types of heaters as the object of the present invention are required that the heaters are quickly heated and thereafter kept at a prescribed temperature. Namely, quick heating characteristic and temperature saturation are required. In order to attain such characteristics, it is necessary that the material has high electrical resistivity ratio (the ratio of the electrical resistivity at a certain temperature with respect to the electrical resistivity at room temperature). Therefore, when the material having high electrical resistivity ratio as mentioned above is used, an electrical resistivity element useful for a glow plug or various types of heaters that exhibits good self temperature control function while maintaining satisfactory quick heating characteristic can be obtained.

Further, corrosion resistance and oxidation resistance at a high temperature as well as workability to various element forms are characteristics required for the heater.

Conventionally, as metal heater materials, metal materials containing, as main component, iron group metal such as iron (Fe), nickel (Ni) and cobalt (Co) have been used. These metals will be considered in view of the characteristics mentioned above. Electrical resistivity ratio of iron much increases as the temperature rises from the room temperature to about 750° C., and iron exhibits good workability during cold working. Among the aforementioned three metals, however, iron is inferior in corrosion resistance and oxidation resistance at a high temperature. Nickel is superior in workability, corrosion resistance and oxidation resistance. Though resistance ratio of nickel much increases up to the magnetic transformation point of 361° C., increase in the electrical resistivity ratio abruptly becomes smaller past that temperature. As compared with nickel, cobalt has rather high magnetic transformation point, and therefore, resistance ratio much increases up to around 900° C. Cobalt, however, is difficult to work, as it has crystal structure of hexagonal system.

The composition defined by the first characteristic of the present invention is determined mainly considering improvement of corrosion resistance and oxidation resistance at a high temperature and workability during cold working, while maintaining the quick heating characteristic and self temperature control function at prescribed levels.

Of these required characteristics, the workability may be improved by changing the crystal structure of the alloy to cubic system that allows easy working. The material having the composition in accordance with the first characteristic of the present invention has the crystal structure of cubic system, and hence workability can be much improved.

Of the components defined by the first characteristic of the present invention, when the content of nickel is smaller than 20 mass %, workability lowers, and it becomes impossible to work to fine wire or to complicated shapes by cold working. Within the above described composition range, the crystal structure of the material is the cubic system, and therefore workability is good enough to easily work the material to a fine wire (having the diameter of at most several hundreds μm) or to complicated shapes by cold working.

When the content of nickel exceeds 60 mass % and the contents of iron attains 5 mass % or higher, corrosion resistance and oxidation resistance degrade, and electrical resistivity ratio becomes smaller. Therefore, it becomes difficult to attain both the quick heating characteristic and the self temperature control function.

Within the above described composition range, abrupt change in volume resulting from phase transformation during temperature increase, which is generally observed in among cobalt-alloy based material, does not occur, and therefore damage to the element by such a change can be prevented.

The second characteristic of the material in accordance with the present invention is that, in addition to the first characteristic described above, the relation x+7y≦70 is satisfied, where nickel content in the material is x mass % and iron content is y mass %.

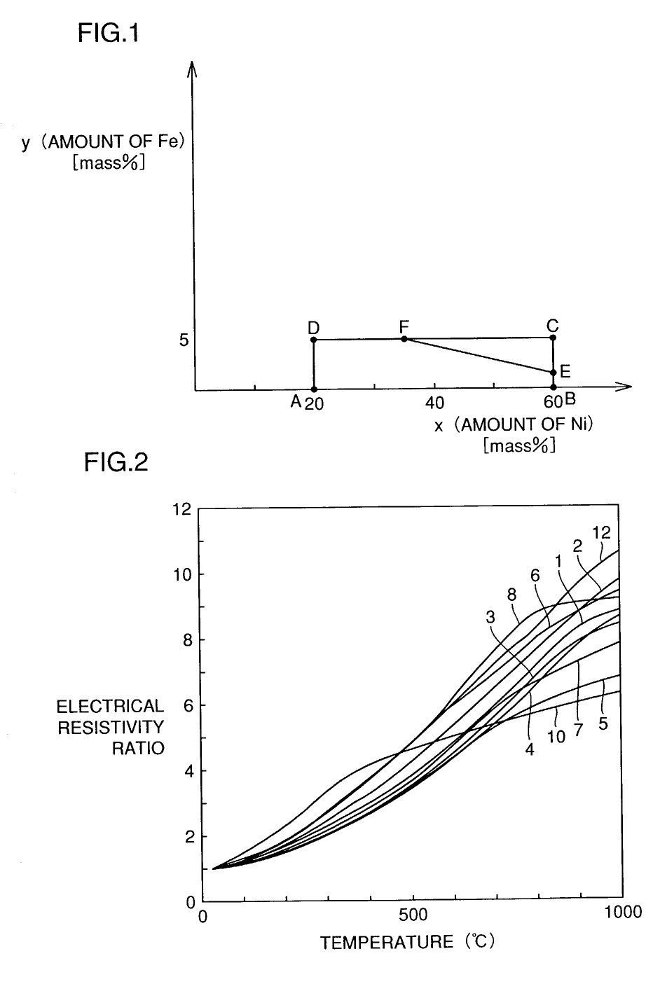

FIG. 1 shows a relation between the composition range in accordance with the first characteristic and the composition range in accordance with the second characteristic of the material in the present invention. Referring to FIG. 1, the ordinate represents iron content, and the abscissa represents nickel content. The ordinate and the abscissa are not of the same scale. Referring to FIG. 1, the portion surrounded by four sides of a rectangle ABCD corresponds to the first composition range, and the portion surrounded by five sides of a pentagon ABEFD corresponds to the second composition range. In both composition ranges, values on the line CD are not included. Coordinates of respective points given as (value of iron mass %, value of nickel mass %) are as follows. A (20, 0), B (60, 0), C (60, 5), D (20, 5), E (60, 1.43) and F (35, 5).

Japanese Patent Laying-Open No. 58-83124 discloses a material for a resistance heater body for glow plug that contains at least 10 weight % of iron. As already described, this material is disadvantageous in view of corrosion resistance and oxidation resistance. In contrast, in the composition range in accordance with the second characteristic of the material in the present invention, good oxidation resistance and corrosion resistance can be attained. More specifically, as the composition has small iron content, good corrosion resistance and oxidation resistance can be attained, and in order to compensate for the reduced amount of iron and to maintain workability, content of nickel is increased in place of iron. The workability can be improved by adding even a small amount of iron, as compared with nickel, and the trade-off between the improved workability by the addition and the adverse effect of lower temperature coefficient of electrical resistivity is better in iron than nickel. However, when iron is added corrosion resistance and oxidation resistance degrade. In the composition range in accordance with the second characteristic of the present invention, the temperature coefficient of electrical resistivity is large while the workability is within the tolerable range, and the change in the coefficient is smooth with respect to temperature, and particularly good oxidation resistance and corrosion resistance can be obtained. This means that degradation from the surface of the material proceeds slowly. Therefore, even when the material is worked to a fine wire or a thin plate in order to accommodate the electrical resistivity element in a compact device, degradation such as increased electrical resistivity resulting from oxidation proceeds slowly, and therefore, sufficient life is ensured for the device including the electrical resistivity element.

The relation between the composition and the function of the material for the electrical resistivity element in accordance with the present invention described above will be summarized with reference to FIG. 1. More specifically, the portion surrounded by four sides of a rectangle ABCD represents the composition range of the present invention in which quick heating characteristic, durability and workability are all satisfactory, and the portion surrounded by five sides of a pentagon ABEFD (second range) represents a range in which the quick heating characteristic and the durability are particularly good. The portion surrounded by three sides of a triangle CEF represents a range in which both the quick heating characteristic and the durability are inferior to those in the second range.

The third characteristic of the material for the electrical resistivity element in accordance with the present invention is, in addition to the first and second characteristics described above, that the content of the unavoidable impurities in the material for the electrical resistivity element is, at most 0.1 mass % of carbon only, or of the total of silicon, titanium, manganese, chromium, aluminum, boron and bismuth. When the content of the unavoidable impurities exceeds 0.1 mass %, workability of the material tends to degrade.

The fourth characteristic of the material for the electrical resistivity element in accordance with the present invention is that, in addition to the basic composition described above, the material further includes at most 3 mass % of each of vanadium and tungsten, or the material further includes at most 8 mass % of molybdenum. Within the range of the contents, better heat resistance including higher strength at a high temperature and creep resistance, corrosion resistance and oxidation resistance of the material can be attained while maintaining the quick heating characteristic and the self temperature control function of the basic composition described above.

The material for the electrical resistivity element in accordance with the present invention is characterized in that the ratio ρ(1000)/ρ(RT) of the electrical resistivity ρ(RT) at the room temperature with respect to the electrical resistivity ρ(1000) at the temperature of 1000° C. is at least 7 and at most 12, and preferably, the temperature coefficient of electrical resistivity increases monotonously from the room temperature. When the electrical resistivity is smaller than 7, the self temperature control function of the material does not work well. The electrical resistivity ratio exceeding 12 is obtained in a cobalt-nickel based alloy with high concentration of cobalt, cobalt-iron based alloy or cobalt-iron based alloy of which iron content is at least 6 mass %, with the amount of added iron increased to utilize the phenomenon that the temperature coefficient of resistance abruptly increases at the time of phase transformation. The former alloy, however, is very difficult to perform cold working. The latter alloy has poor corrosion resistance and oxidation resistance, as iron content is high. The material of which electrical resistivity ratio exceeds 12 naturally has the self temperature control function. Even within the range of the electrical resistivity ratio of the present invention, however, the self temperature control function can fully be exhibited. Therefore, in accordance with the present invention, a material that has superior corrosion resistance and oxidation resistance and has such an electrical resistivity ratio that enables exhibition of self temperature control function can be obtained.

In order to more effectively realize the self temperature control function, it is desirable that the temperature coefficient of electrical resistivity increases monotonously up to the temperature where control is desired. In order to obtain such a temperature coefficient of electrical resistivity, content of nickel, iron, vanadium, tungsten or molybdenum may be adjusted within the range of the present invention, in accordance with the required temperature, provided that the temperature range is up to 1000° C.

The material for the electrical resistivity element of the present invention has superior workability, and thus it can be worked to the necessary diameter or thickness. Further, the material of the present invention is characterized in that the number of heat treatment to recover toughness of the material can be made small. Further, toughness of the material in accordance with the present invention is not lost in the state as it is cold-worked. Therefore, it can be formed to a coil directly from the state as it is worked to a wire by cold working. When the material of the present invention is to be worked to the shape of a coil, use of the wire material that has been work-hardened, that is, the material as cold-worked, should be used, as better productivity is expected, since the material as cold-worked exhibits superior coil forming property using a correction roller or a jig, as compared with the material that has been heat-treated.

The method of manufacturing a material for the electrical resistivity element in accordance with the present invention is characterized in that reduction of cold working after hot working or after annealing is at least 75%. This characteristic ensures that after casting the material, the time of heat treatment necessary for working the material to a prescribed size, for example, a diameter, can be made small. As the possible reduction of cold-working is large, it is possible to use a continuous wire drawer, whereby the material can be worked at a low cost. Further, the above described characteristic is based on the finding that corrosion resistance and oxidation resistance differ dependent on the magnitude of the reduction of cold working. Specifically, it has been found that the material cold-worked with the reduction of at least 75% has superior oxidation resistance as compared with the material cold-worked with the reduction of lower than 75%. At a low temperature where re-crystallization of the material does not proceed, oxidation also proceeds slowly. Therefore, relation between oxidation resistance and the reduction of working is not recognized. At a high temperature at which the material of the present invention would be mainly used, that is, in the temperature range where the material re-crystallizes, the relation between oxidation resistance and the reduction of working becomes clear. The reason for this may be that the behavior of re-crystallization differ dependent on the magnitude of the reduction of cold-working, resulting in variation of crystal grain size, so that the diffusion rate to the surface differ, affecting the oxidation resistance. In the present invention, in order to attain good corrosion resistance and oxidation resistance, content of iron is limited. By optimizing the reduction of cold working, it becomes possible to attain better corrosion resistance and oxidation resistance. As a result, the life of the electrical resistivity element using the material of the present invention can be made longer.

As described above, in order to improve quick heating characteristic and current control function when power is fed and the temperature is increased, it is desired that the electrical resistivity ratio is larger. In the composition range of the present invention in which corrosion resistance, oxidation resistance and workability are of higher priority, however, generally, the electrical resistivity ratio rarely exceeds 12. It is noted that compositions disclosed in Japanese Patent Laying-Open Nos. 58-83124 and 2-133901 may have the electrical resistivity ratio exceeding 12. Such compositions, however, are inferior in corrosion resistance and oxidation resistance as compared with the material of the present invention, mainly because of different contents of nickel and iron. In the present invention, the material has the sufficient quick heating characteristic and the temperature control function. Therefore, reduction of freedom in practical design of the electrical resistivity element increases. Further, as the material of the present invention has good oxidation resistance and corrosion resistance, an electrical resistivity element having high performance and high reliability can be provided.

### EXAMPLE 1

Materials of Sample Nos. 1 to 12 having the chemical compositions shown in Table 1, weighted such that respective components are contained by the prescribed contents, were melted in a vacuum atmosphere by an induction furnace, cast in molds having the diameter of 25 mm, and ingots were obtained. In order to remove surface defects generated at the time of casting, the surfaces of the ingots were peeled, and thereafter, the samples were subjected to hot forging to provide wire materials having the diameter of 10 mm. The wire materials were subjected to heat treatment at a temperature of 900° C. for 1 hour, and thereafter subjected to cold wire drawing and heat treatment, repeatedly. Except for the samples that could not be worked, the samples were thus worked to wires having the diameter of 0.3 mm. A commercially available nickel wire was used as Sample No. 10. A wire prepared by nickel-plating a commercially available steel wire was used as Sample No. 8. In Table 1, Sample No. 2-1 has the same chemical composition as Sample No. 2-2, and the diameters of the wires during heat treatment were adjusted to change the reduction of cold working until obtaining the final diameter. The reduction of cold working was 70% for the Sample No. 2-1, while it was 85% for the Sample No. 2-2.

The ratio between the electrical resistivity value at 1000° C. and the electrical resistivity at the room temperature (electrical resistivity ratio) of each sample that could be worked obtained in this manner, the tendency of the temperature coefficient of electrical resistivity with respect to temperature, limit reduction of cold working, and oxidation resistance were evaluated. The results are as shown in Table 1. The change of the electrical resistivity ratio of these samples with respect to temperature is as shown in FIG. 2.

TABLE 1

| | | | | | | | | | | | Temperature | Limit | |
|---|---|---|---|---|---|---|---|---|---|---|---|---|---|
| | | | | | | | | | | Electrical | Coefficient | Reduction | |
| | Sample | Contents (mass %) | | | | | | | | Resistivity | of Electrical | of Cold | Oxidation |
| | No. | Ni | Fe | Co | V | W | Mo | C | Impurities | Ratio | Resistivity | Working | Resistance |
| Examples | 1 | 40 | — | Balance | — | — | — | 0.04 | 0.07 | 8.9 | ◯ | 90% | 5 |
| | 2-1 | 25 | 4 | Balance | — | — | — | 0.02 | 0.08 | 9.8 | ◯ | 92% | 4 |
| | 2-2 | 25 | 4 | Balance | — | — | — | 0.02 | 0.08 | 9.8 | ◯ | 92% | 5 |
| | 3 | 45 | 2 | Balance | 1.5 | 1.1 | 5.0 | 0.06 | 0.04 | 8.5 | ◯ | 88% | 5 |
| | 4 | 40 | 4 | Balance | — | — | — | 0.02 | 0.02 | 8.7 | ◯ | 93% | 4 |
| | 5 | 55 | 1 | Balance | 3.3 | 1.6 | 4.5 | 0.03 | 0.08 | 6.7 | X | 86% | 5 |
| | 6 | 25 | 2 | Balance | — | — | — | 0.15 | 0.03 | 9.5 | ◯ | 75% | 5 |
| | 7 | 50 | 4 | Balance | — | — | — | 0.03 | 0.05 | 7.9 | X | 90% | 3 |
| Comparative | 8 | Ni-plated Steel Wire | | | | | | | | 9.2 | X | — | 1 |
| Examples | 9 | — | 4 | Balance | — | — | — | 0.02 | 0.03 | — | — | not | — |
| | | | | | | | | | | | | workable | |
| | 10 | 100 | — | — | — | — | — | — | — | 6.3 | X | at least | 5 |
| | | | | | | | | | | | | 99% | |
| | 11 | 10 | 4 | Balance | — | — | — | 0.02 | 0.26 | — | — | not | — |
| | | | | | | | | | | | | workable | |
| | 12 | — | 8 | Balance | — | — | — | 0.02 | 0.04 | 10.7 | ◯ | 92% | 2 |

In Table 1, “∘” in the column of “temperature coefficient of electrical resistivity” represents that the temperature coefficient of electrical resistivity was increased monotonously from the room temperature to the temperature of 800° C., and “×” in this column represents that the temperature coefficient of electrical resistivity was not monotonously increased from the room temperature to 800° C. Further, “impurities” represent total contents of carbon, silicon, titanium, manganese, chromium, aluminum, boron and bismuth, as unavoidable impurities. The value “5” of oxidation resistance represents superior oxidation resistance, “4” represents excellent, “3” fair, “2” not satisfactory, and “1” poor. Evaluation of oxidation resistance was performed after each sample was held at 900° C. for 50 hours in the ambient atmosphere.

It can be understood from Table 1 and FIG. 2 that Sample Nos. 1 to 7 of the present invention have good workability and large electrical resistivity ratio between a high temperature and the room temperature, and further the materials have good oxidation resistance.

### EXAMPLE 2

Some of the samples obtained in Example 1 were worked to wires having the diameter of 0.1 mm or smaller and thereafter coiled, and filled together with magnesia as an insulating material, in a pipe of SUS316. Thus heaters for localized heating were fabricated. A DC voltage of 5V was applied to the heaters, and the time from the start of conduction until the temperature of 500° C. was reached (500° C. reaching time) was measured. Further, a heat cycle test was repeated for 100,000 cycles, in which conduction and heating with DC voltage of 5V for 10 sec was followed by current breaking for 10 sec, as the endurance test. The results of measurement are as shown in Table 2.

TABLE 2

| | | | 500° C. | Steady | |
|---|---|---|---|---|---|
| | | Material | Reaching | Temper- | Endurance |
| | | Used | Time | ature | Test |
| Examples | 101 | Sample No. 1 | 1.2 sec. | 600° C. | ◯ |
| | 102 | Sample No. 2 | 1.1 sec. | 600° C. | ◯ |
| Comparative | 103 | Sample No. 8 | 1.1 sec. | 600° C. | X |
| Examples | 104 | Sample No. 12 | 1.0 sec. | 600° C. | Δ |
| | 105 | Pure Ni | 1.8 sec. | 600° C. | ◯ |

In Table 2, “steady temperature” represents a temperature at which the temperature becomes constant, after conduction. As to “endurance test”, “∘” represents that none of the sample items was broken, “Δ” represents that some of the sample items were broken, and “×” represents that all the sample items were broken.

From Table 2, it can be understood that when the materials in accordance with the present invention are used, it is possible to fabricate a very small heater having both the quickly heating property and the oxidation resistance, and that the materials of the present invention can be used for connecting electronic components, for example, in which the conduction-disconnection cycle frequently takes place.

Although the present invention has been described and illustrated in detail, it is clearly understood that the same is by way of illustration and example only and is not to be taken by way of limitation, the spirit and scope of the present invention being limited only by the terms of the appended claims.

### INDUSTRIAL APPLICABILITY

The material for the electrical resistivity element of the present invention is useful as materials for glow plugs and various heaters.

1. A material for an electrical resistivity element, containing at least 20 mass % and at most 60 mass % of nickel, less than 5 mass % of iron, and a remaining part including unavoidable impurities and cobalt.

2. The material for an electrical resistivity element according to claim 1, satisfying the relation of x+7y≦70, where x and y represent contents of said nickel and iron, by the unit of mass %.

3. The material for an electrical resistivity element according to claim 1, containing at most 0.1 mass % of carbon only, and at most 0.1 mass % of a total of silicon, titanium, manganese, chromium, aluminum, boron an bismuth, as the contents of said unavoidable impurities.

4. The material for an electrical resistivity element according to claim 1, further containing at most 3 mass % of each of vanadium and tungsten, and at most 8 mass % of molybdenum.

5. The material for an electrical resistivity element according to claim 1, wherein ratio ρ(1000)/ρ(RT) is at least 7 and at most 12, where ρ(RT) represents electrical resistivity of the material for the electrical resistivity element at a room temperature, and ρ(1000) represents electrical resistivity of the material for the electrical resistivity element at a temperature of 1000° C.

6. An electrical resistivity element using a material that contains at least 20 mass % and at most 60 mass % of nickel, less than 5 mass % of iron and a remaining part including unavoidable impurities and cobalt.

7. The electrical resistivity element according to claim 6, wherein said material is used in a shape of a coil.

8. A method of manufacturing a material for an electrical resistivity element, comprising:
the first step of preparing a composition containing at least 20 mass % and at most 60 mass % of nickel, less than 5 mass % of iron and a remaining part including cobalt;
the second step of melting and casting said composition to obtain an ingot;
the third step of hot-working said ingot and removing a surface; and
the fourth step of performing cold-working and heat treatment on said hot-worked body.

9. The method of manufacturing a material for an electrical resistivity element according to claim 8, wherein
manufacturing is completed by the cold working of the fourth step.

10. The method of manufacturing an electrical resistivity element according to claim 8, wherein
reduction of the cold working in said fourth step is at least 75%.

11. The method of manufacturing a material for an electrical resistivity element according to claim 8, wherein
the cold working in said fourth step includes wire drawing.
